(19) United States
(12) Patent Application Publication
(10) Pub. No.: US 2013/0119722 A1
(43) Pub. Date: May 16, 2013

(54) Energy Absorbing Anchor for Child Safety Seat

(71) Applicants: Brian Robert Spahn, Plymouth, MI (US); Richard Edward Ruthinowski, Taylor, MI (US); Anthony Edmond Rencher, Southfield, MI (US); Parakarma Valentine Weerappuli, West Bloomfield, MI (US)

(72) Inventors: Brian Robert Spahn, Plymouth, MI (US); Richard Edward Ruthinowski, Taylor, MI (US); Anthony Edmond Rencher, Southfield, MI (US); Parakarma Valentine Weerappuli, West Bloomfield, MI (US)

(73) Assignee: FORD GLOBAL TECHNOLOGIES, LLC, Dearborn, MI (US)

(21) Appl. No.: 13/294,358

(22) Filed: Nov. 11, 2011

(51) Int. Cl. B60N 2/42; B60N 2/44

(52) U.S. Cl. 297/216.11

(57) ABSTRACT

A bracket for securing a child seat in a vehicle includes a base, a tether connection portion receiving a tether extending from the child seat, and a hinge portion connecting the base portion and the connection portion. The hinge portion deforms when a designed yield load is applied to the tether connection portion by the tether. A deflection stop adjacent the hinge portion contacts the tether connection portion to limit rotation of the tether connection portion. A rotation limiter secured to the vehicle contacts the bracket to limit its rotated about an axis generally perpendicular to a mounting surface. The base portion includes a first plate and a second plate joined by a load tuning bend permitting adjustment of a mounting angle between the first and second plate. to further tune the deflection loading of the bracket for a particular installation.

### TECHNICAL FIELD

The present invention relates to child safety seats of the type that are secured in the rear seat of a vehicle passenger compartment. More specifically, the invention relates to an anchor bracket secured to the vehicle and to which a top tether of a child safety seat is attached to secure the seat in position.

### BACKGROUND

Occupants of moving vehicles are subjected to crash forces when the vehicle experiences a sudden deceleration, such as from sudden braking and/or striking another object. For vehicle occupants restrained by lap and/or shoulder belts, the crash forces can be reduced by allowing controlled deformation of energy absorbing elements attached to the seat belts. Such as the case with load-limiting seat belt retractors found in most new cars produced for sale in the developed world.

Children restrained in after-market child safety seats may also benefit from controlled deformation of energy absorbing elements during a crash or deceleration event. Child safety seats are generally designed to be secured onto a rear passenger seat of the passenger compartment, either using the same seat belt hardware used to restrain an adult-sized occupant or using anchors and/or straps specifically intended for a child seat.

### SUMMARY

In a disclosed embodiment, a bracket for securing a tether of a child seat to an automotive vehicle comprises a base portion securable to an anchor location in the vehicle, a tether connection portion having a connecting feature for securing the tether, and a hinge portion connecting the base portion and the connection portion. The base portion and the tether connection portion form an interior angle, and the hinge portion deforms when a designed yield load is applied to the tether connection portion by the tether. The deformation of the hinge portion allows the tether connection portion to rotate relative to the base portion about the hinge portion.

In a further embodiment, a deflection stop adjacent the hinge portion and outside the interior angle contacts the tether connection portion when deformation of the hinge portion has allowed the tether connection portion to rotate to a maximum deflection position. This prevents excessive forward excursion of the safety seat.

In a further embodiment, a rotation limiter, which may be secured to the vehicle or integral to the bracket, is adjacent to the base portion and contacts the bracket when the bracket has rotated to a maximum permitted rotation angle about an axis generally perpendicular to a mounting surface. Contact between the bracket and the rotation limiter impedes rotation of the bracket past the permitted rotation angle, thereby preventing excessive lateral excursion of the safety seat.

In a further embodiment, the base portion comprises a first plate and a second plate joined along a common edge by a load tuning bend permitting adjustment of a mounting angle between the first and second plate. The mounting angle may be adjusted to further tune the deflection loading of the bracket for a particular installation.

In a further embodiment, an anchoring system for securing a child safety seat within an interior of an automotive vehicle comprises a mounting surface within the vehicle interior and an energy absorbing bracket. The bracket comprises a base portion secured to the mounting surface to prevent forward movement of the base portion, a tether connection portion having a connecting feature for securing a tether extending forward and attached to a child safety seat, and at least one hinge portion connecting a forward-most edge of the base portion and a forward-most edge of the connection portion. The base portion and the tether connection portion form an interior angle, and the hinge portion deforms when a designed yield load is applied to the tether connection portion by the tether, such that the tether connection portion rotates relative to the base portion about the hinge portion.

In a further embodiment, a child safety arrangement for an automotive vehicle comprises a child safety seat positioned on a seat of the vehicle, an upper tether extending rearward from an upper portion of the child safety seat, a mounting surface located rearward of the vehicle seat, and an anchor bracket secured to the mounting surface. The anchor bracket comprises a base portion secured to the mounting surface to prevent forward movement of the base portion, a tether connection portion engaged with the upper tether, and a hinge portion connecting a forward-most edge of the base portion and a forward-most edge of the connection portion. The base portion and the tether connection portion form an interior angle, and the hinge portion has a cross-sectional area smaller than the cross-sectional areas of adjoining portions of the base portion and the tether connection portion.

### BRIEF DESCRIPTION OF THE DRAWINGS

FIG. 1 is a partial schematic view of a rear seating area of a vehicle passenger compartment;

FIG. 2 is a perspective view of an anchor bracket and associated angle associated adjustment wedge;

FIG. 3 is a partial side view of the anchor bracket installation shown in FIG. 1;

FIG. 4 is a perspective view of an anchor bracket having a load tuning bend;

FIG. 5 is a perspective view of another embodiment of an anchor bracket having a load tuning bend;

FIG. 6 is a perspective view of another embodiment of an anchor bracket and an associated deflection stop;

FIG. 7 is a schematic side view of the anchor bracket and deflection stop of FIG. 6 with the bracket in a deflected condition;

FIG. 8 is a perspective view of an anchor bracket and associated rotation stop plate;

FIG. 9 is a top view of the anchor bracket and rotation stop plate of FIG. 8;

FIG. 10 is a top view of the anchor bracket and rotation stop plate of FIG. 8 in a rotated condition; and

FIG. 11 is a partial schematic view of a rear seating area of a vehicle passenger compartment with a roof-mounted anchor bracket.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

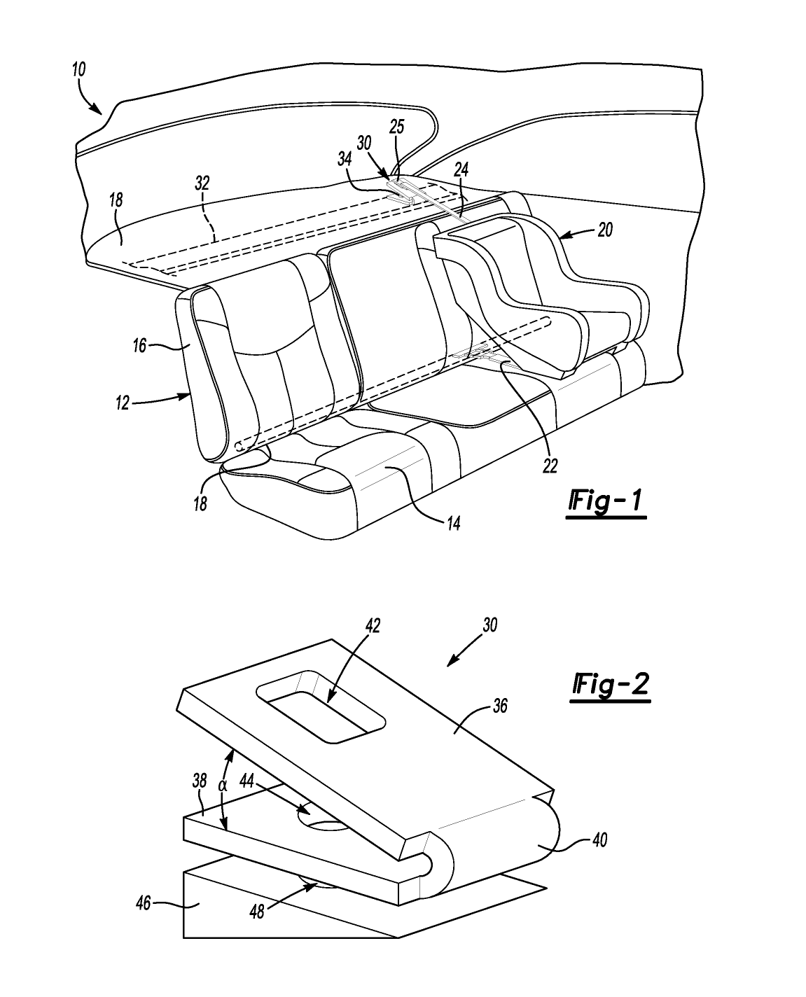

Referring to FIG. 1, a rear seating row 10 of a vehicle passenger compartment comprises a bench-style seat 12 made up of a seat bottom 14 and a seat back 16. Rear seating row 10 further comprises a package shelf 18 that is generally horizontal and extends rearward from a point adjacent an upper edge of the seat back 16. A child safety seat 20 is positioned on seat 12. Child safety seat 20 may be any of numerous types of after-market products sold to fit children in the approximately 20-85 pound weight range. The vehicle environment shown in FIG. 1 is representative of a typical passenger sedan, but the invention may be used in any type of vehicle having provisions for installing a child safety seat,

As is well known in the child safety seat art, safety seat 20 is secured in position by one or more lower tethers 22 removably fastened to one or more lower anchor points located adjacent the juncture between the lower edge of seat back 16 and rear edge of seat bottom 14. Safety seat 20 is further secured in position by one or more upper tethers 24 extending rearward from an upper portion of the seat and secured to an anchor point by, for example, a hook 25 connected to the tether 24 in a manner allowing adjustment of the length of the tether.

An upper anchor bracket 30 is secured to a mounting location on or adjacent to package shelf 18. Bracket 30 may be secured to a reinforcing beam 32 or other structural member disposed below the visible surface of the package shelf 18. Bracket 30 may be secured in position by a fastener 34, such as a bolt.

Referring now to FIG. 2, anchor bracket 30 comprises a tether connection portion 36, a base portion 38, and a deformable hinge portion 40 joining the base portion with the tether connection portion. Base portion 38 and tether connection portion 36 form an interior angle α. Anchor bracket 30 is preferably formed from a single piece high-strength material such as steel. Any fabrication method appropriate to the material may be used to achieve the desired shape of the bracket.

Hinge portion 40 may be “notched” on either side or otherwise made narrower than the overall width of base portion 38 and tether connection portion 36, as shown in FIG. 2. The reduced width of hinge portion 40 serves to decrease the cross-sectional area, this being one feature of the bracket that may be tuned to achieve a desired yield load, as is further described below.

Tether connection portion 36 comprises a connecting feature, which in the illustrated embodiment is a through-hole or window 42. Window 42 is sized to receive hook 25 or other fastening device attached to upper tether 24.

A through-hole 44 is formed in base portion 38 to receive fastener 34 and thereby fasten the anchor bracket 30 to the vehicle. Fastener 34 may be a shoulder bolt or other fastening means permitting bracket 30 to rotate relative to its mounting surface/location. This may be desirable if a particular installation geometry results in tether 24 extending from bracket 30 in a direction other than directly perpendicular to the bend line formed by hinge 40. Rotation of bracket 30 about an axis defined by fastener 34 provides a “self-aligning” feature so the bracket rotates to a position in which the load applied by tether 24 is perpendicular to hinge 40, allowing a consistent functioning of the bracket. The fastening arrangement may be designed to provide a desired amount of resistance to rotation of bracket 30. This rotational resistance may, for example, be controlled by adjusting the amount of downward (clamping) force applied to bracket base 38 by fastener 34 and/or the amount of interference between the outside diameter of the fastener and the inside diameter of through-hole 44. Alternatively, an anti-rotation tab or post (not shown) may be provided.

An angle adjustment wedge 46 may be positioned between the bottom of angle bracket 30 and the mounting surface to which the bracket is secured. Angle adjustment wedge 46 includes a hole 48 to receive fastener 34. Angle adjustment wedges of various thicknesses and angles may be used in combination with a single, standard angle bracket, so that only the standard angle bracket need be manufactured for use in differing vehicle installations and still achieve a desired angle between the tether connection portion 36 and upper tether 24.

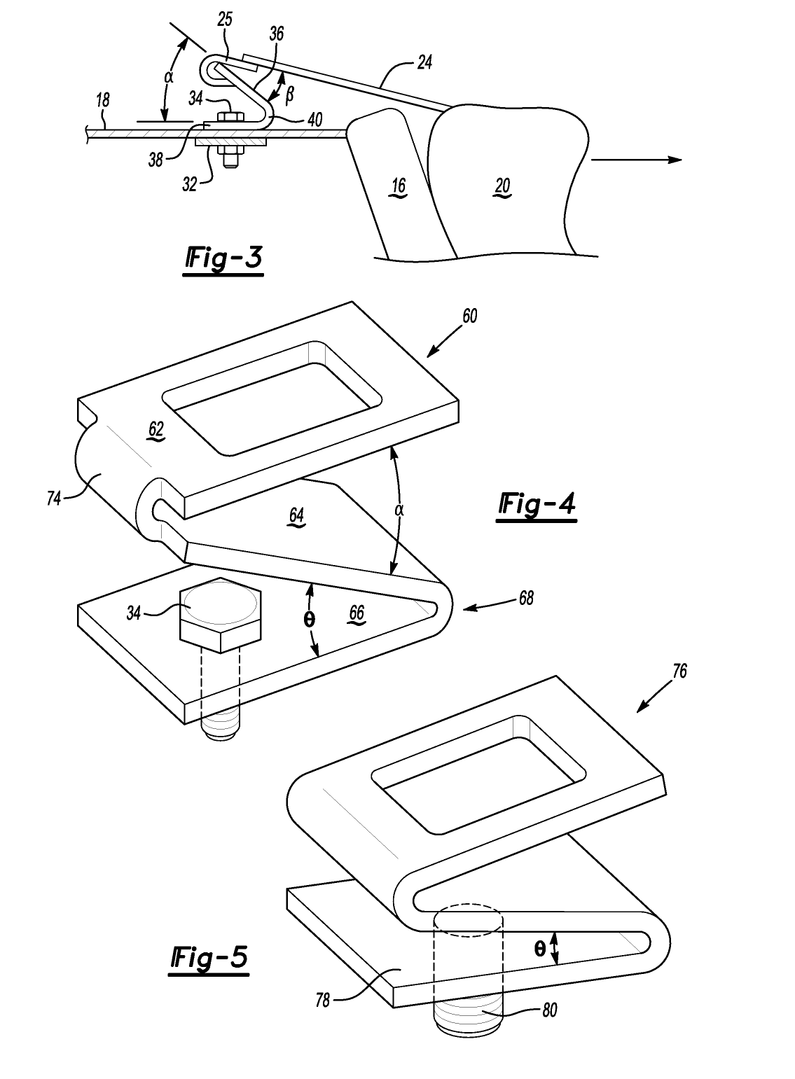

As best seen in FIG. 3, safety seat 20 is positioned on bench seat 12 and hook 25 attached to upper tether 24 is placed in engagement with bracket 30 by hooking it through window 42 in tether connection portion 36. When upper tether 24 is drawn tight it forms an angle β with tether connection portion 36.

During rapid deceleration of the vehicle experienced during a collision, safety seat 20 undergoes a forward inertial acceleration (relative to the vehicle) so that upper tether 24 is loaded in tension and hook 25 pulls on tether connection portion 36. Bracket 30 is engineered to plastically yield when the load reaches a predetermined limit so as to absorb energy and decrease the crash forces experienced by a child occupying safety seat 20. As is apparent to a person skilled in the mechanical arts, bracket 30 will yield when the bending moment applied to hinge 40 reaches a critical value, which in turn depends upon the material properties and cross-section size/shape at the hinge.

For a particular installation, the level of vehicle deceleration that results in bracket yielding can be adjusted or tuned by changing the angle β between tether 24 and tether connection portion 36. As mentioned above, one way to tune β to lie in a desired range is to use an angle adjustment wedge 46 of the correct angle and thickness beneath bracket 30.

A second embodiment of an anchor bracket 60 shown in FIG. 4 comprises a tether connection portion 62 and a base that includes an upper plate 64 and a lower plate 66 joined by a load tuning bend 68. Lower plate 66 has a through-hole 70 for receiving a fastener 34 such as a bolt. Mounting angle θ between upper plate 64 and lower plate 66 may be set to a desired value to tune the force/deflection characteristics of bracket 60. Load tuning bend 68 provides an additional feature that can be used to adapt the bracket for a greater range of occupant/seat sizes and weights depending on vehicle parameters. Angle α may also be adjusted to tune the force/deflection characteristics of the anchor bracket.

Another embodiment of an anchor bracket 76 shown in FIG. 5 differs from FIG. 4 in that lower plate 78 has a fastening stud 80 projecting downwardly therefrom.

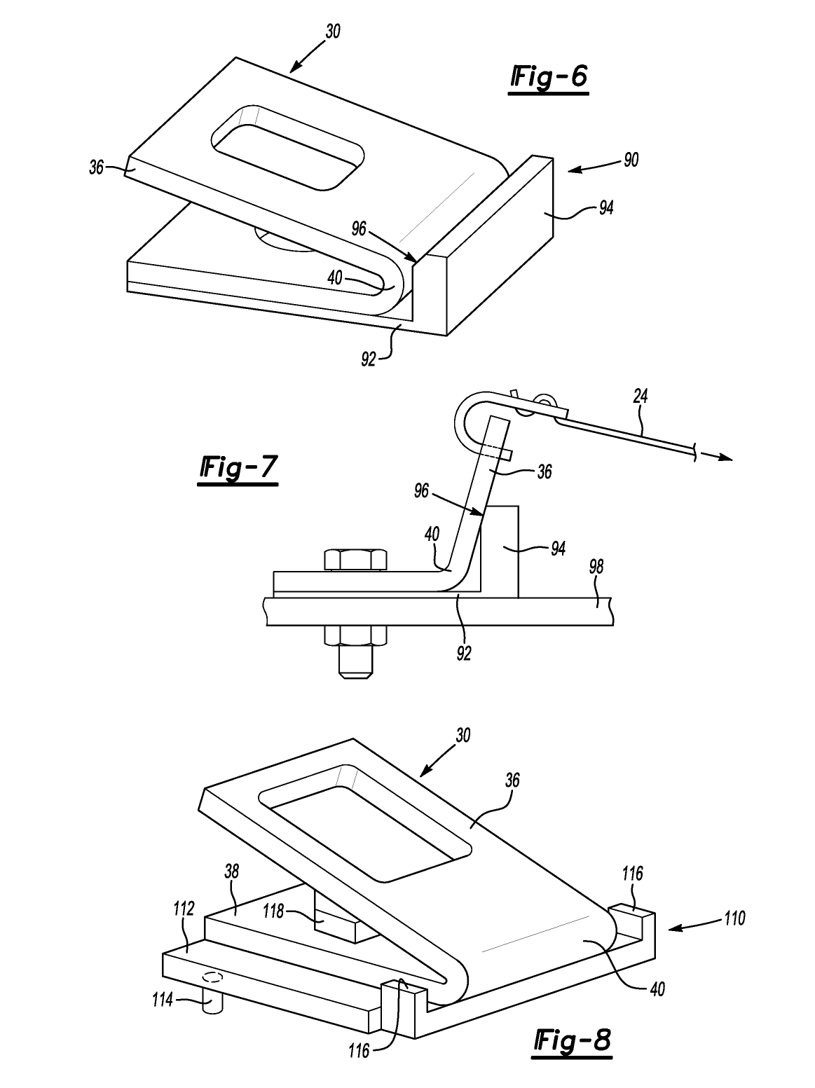

FIGS. 6 and 7 illustrate an anchor bracket 30 substantially similar to that shown in FIG. 2 used in combination with a deflection stop 92. Deflection stop 90 comprises a base 92 and a stop block 94 having a beveled or angled contact face 96. Deflection stop 92 is secured to a mounting surface 98 beneath bracket 30 (preferably by the same fastener used to secure the bracket) with stop block 96 adjacent the hinge of the bracket.

As seen in FIG. 7, when bracket 30 yields under the load applied by tether 24, tether connection portion 36 rotates about the hinge until it comes into contact with contact face 96, at which point stop block 94 resists further deformation of the bracket. The position at which tether connection portion 36 is stopped by contact with stop block 94 is referred to as the maximum deflection position. The maximum deflection position may be selected because further bending of connection portion 36 would absorb an insignificant additional amount of energy, and/or would allow excessive forward excursion of the safety seat.

FIGS. 8-10 illustrate an anchor bracket 30 substantially similar to that shown in FIG. 2 used in combination with a rotation limiter 110. Rotation limiter 110 includes a base 112 which may include downward-projecting studs 114 that engage holes or recesses formed in the mounting surface (not shown) at the appropriate location. Other known means (fasteners, screws, adhesives, etc.) may be used to mount rotation limiter 110 to the surface.

Stop tabs 116 extend upwardly from base 112 at an end of limiter 112. Rotation limiter 112 is installed beneath bracket 30 (between bracket base 38 and the mounting surface) so that hinge 40 is between stop tabs 116. The lateral distance between stop tabs 116 is greater than the width of bracket 30 by a designed amount to define the allowable amount of rotation of the bracket relative to the limiter 112.

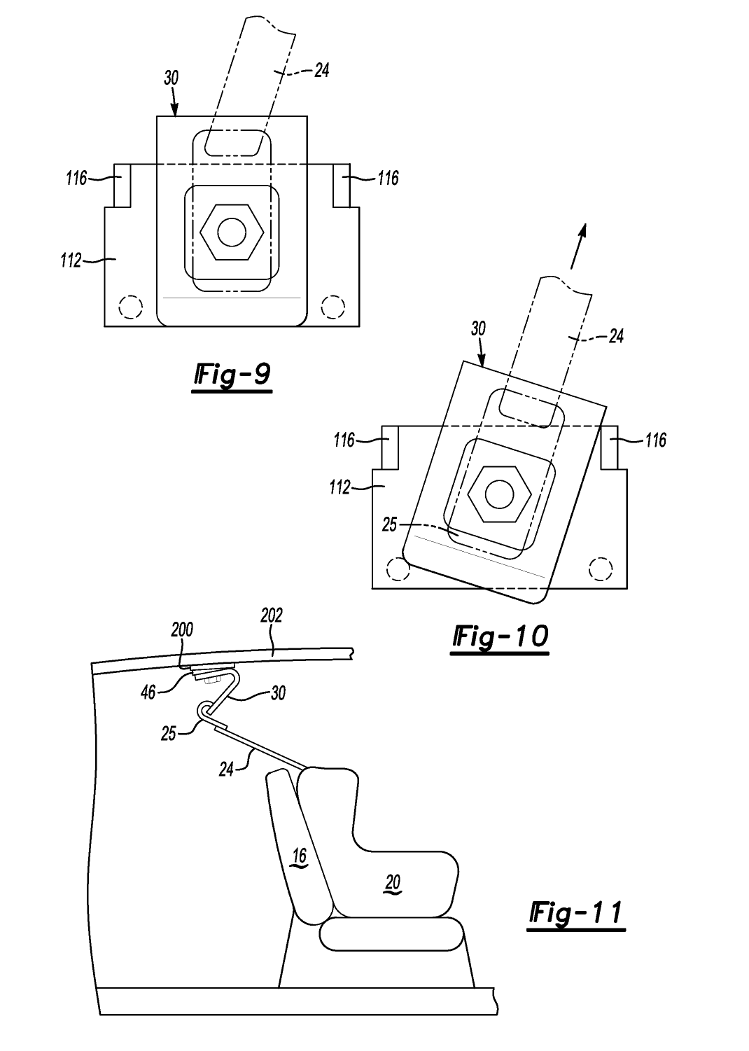

Rotation limiter 112 is used in combination with a bracket 30 that is secured to the mounting surface by a fastener 118 (such as a shoulder bolt) permitting the bracket to rotate, so as to achieve the self-aligning feature described hereinabove. Rotation may occur if tether 24 (shown in phantom lines) extends from bracket 30 in a direction not aligned with the bracket itself (see FIG. 9). If this non-aligned load is great enough to overcome frictional resistance of the fastening arrangement, bracket 30 will rotate until it contacts one of tabs 116 (see FIG. 10). Limiting the amount that bracket 30 is able to rotate may be desirable to avoid contact of the child safety seat with vehicle interior components or other objects/occupants in the cabin due to excessive lateral excursion.

FIG. 11 shows an upper tether anchor as it may exist in vehicle without a package shelf or other suitable structure directly behind seat back 16 (such as a van or a sport utility vehicle). In such a vehicle, the available mounting point for an anchor bracket 30 may be well above the top of seat back 16, such as on a body panel or reinforcement member 200 adjacent to or forming part of the roof 202. In the depicted roof anchor installation, angle adjustment wedge 46 is used in combination with bracket 30 to achieve the desired angular relationship between the tether connection portion and the direction of loading applied by tether 24, thus assuring that the bracket deforms as desired during a sudden vehicle deceleration.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A bracket for securing a tether of a child seat to an automotive vehicle comprising:
a base portion securable to an anchor location in the vehicle;
a tether connection portion having a connecting feature for securing the tether; and
a hinge portion connecting the base portion and the connection portion, the base portion and the tether connection portion forming an interior angle, the hinge portion deforming when a designed yield load is applied to the tether connection portion by the tether, such that the tether connection portion rotates relative to the base portion about the hinge portion.

2. The apparatus of claim 1 further comprising a deflection stop disposed adjacent the hinge portion and outside the interior angle, the deflection stop located to contact the tether connection portion when deformation of the hinge portion has allowed the tether connection portion to rotate to a maximum deflection position.

3. The apparatus of claim 1 further comprising a rotation limiter securable to the vehicle adjacent to the base portion to contact the bracket when the bracket has rotated through a permitted rotation angle about an axis generally perpendicular to a mounting surface, contact between the bracket and the rotation limiter impeding rotation of the bracket past the permitted rotation angle.

4. The apparatus of claim 3 wherein a hole is formed in the base portion for receiving a fastener to secure the bracket to the mounting surface, the fastener defining the axis of rotation, and the rotation limiter is securable between the base portion and the mounting surface.

5. The apparatus of claim 1 wherein the base portion comprises:
a first plate having a first edge joined to the hinge portion and an opposite second edge; and
a second plate joined to the first plate along the second edge by a load tuning bend permitting adjustment of a mounting angle between the first and second plate, the second plate having a mounting feature for securing the bracket to the anchor location.

6. The apparatus of claim 1 wherein the hinge portion has a cross-sectional area smaller than cross-sectional areas of adjoining portions of the base portion and the tether connection portion, the hinge portion cross-sectional area selected to achieve a desired yield load for the bracket.

7. The apparatus of claim 1 further comprising a wedge contacting a lower surface the base portion, the wedge sandwiched between the lower surface and the mounting surface.

8. An anchoring system for securing a child safety seat within an interior of an automotive vehicle comprising:
a mounting surface within the vehicle interior; and
an energy absorbing bracket comprising:
a base portion secured to the mounting surface to prevent forward movement of the base portion;
a tether connection portion having a connecting feature for securing a tether extending forward and attached to a child safety seat; and
a hinge portion connecting a forward-most edge of the base portion and a forward-most edge of the connection portion, the base portion and the tether connection portion forming an interior angle, the hinge portion deforming when a designed yield load is applied to the tether connection portion by the tether, such that the tether connection portion rotates relative to the base portion about the hinge portion.

9. The apparatus of claim 8 further comprising a deflection stop secured to the mounting surface adjacent to the bracket to contact the tether connection portion when deformation of the hinge portion has allowed the tether connection portion to rotate to a desired deflection position.

10. The apparatus of claim 8 further comprising a rotation limiter secured to the mounting surface adjacent to the bracket to contact the bracket when the bracket has rotated through a permitted rotation angle about an axis generally perpendicular to the mounting surface, contact between the bracket and the rotation limiter impeding rotation of the bracket past the permitted rotation angle.

11. The apparatus of claim 10 wherein a hole is formed in the base portion for receiving a fastener to secure the bracket to the mounting surface, the fastener defining the axis of rotation, and the rotation limiter is secured between the base portion and the mounting surface.

12. The apparatus of claim 8 wherein the base portion comprises:
a first plate having a first edge joined to the hinge portion and an opposite second edge; and
a second plate having the mounting feature and joined to the first plate along the second edge by a load tuning bend permitting adjustment of a mounting angle between the first and second plates.

13. The apparatus of claim 8 wherein the hinge portion has a cross-sectional area smaller than cross-sectional areas of adjoining portions of the base portion and the tether connection portion, the hinge portion cross-sectional area selected to give a desired yield load for the bracket.

14. The apparatus of claim 8 further comprising a wedge positioned between the base portion and the mounting surface.

15. A child safety seat anchorage system for an automotive vehicle comprising:
an upper tether for attachment to an upper portion of a child safety seat;
an upper anchor point disposed adjacent to a package shelf of the vehicle, the upper anchor point securing.

16. A child safety arrangement for an automotive vehicle comprising:
a child safety seat positioned on a seat of the vehicle;
an upper tether extending rearward from an upper portion of the child safety seat;
a mounting surface located rearward of the vehicle seat; and
an anchor bracket secured to the mounting surface, the anchor bracket comprising:
a base portion secured to the mounting surface to prevent forward movement of the base portion;
a tether connection portion engaged with the upper tether; and
a hinge portion connecting a forward-most edge of the base portion and a forward-most edge of the connection portion, the base portion and the tether connection portion forming an interior angle, the hinge portion having a cross-sectional area smaller than cross-sectional areas of adjoining portions of the base portion and the tether connection portion.

17. The apparatus of claim 16 further comprising a deflection stop secured to the mounting surface adjacent to the bracket to contact the tether connection portion when deformation of the hinge portion has allowed the tether connection portion to rotate to a desired deflection position.

18. The apparatus of claim 16 further comprising a rotation limiter secured to the mounting surface adjacent to the bracket to contact the bracket when the bracket has rotated through a permitted rotation angle about an axis generally perpendicular to the mounting surface, contact between the bracket and the rotation limiter impeding rotation of the bracket past the permitted rotation angle.

19. The apparatus of claim 18 wherein a hole is formed in the base portion for receiving a fastener to secure the bracket to the mounting surface, the fastener defining the axis of rotation, and the rotation limiter is secured between the base portion and the mounting surface.

20. The apparatus of claim 16 wherein the base portion comprises:
a first plate having a first edge joined to the hinge portion and an opposite second edge; and
a second plate having the mounting feature and joined to the first plate along the second edge by a load tuning bend permitting adjustment of a mounting angle between the first and second plates.
